(19) United States
(12) Patent Application Publication
(10) Pub. No.: US 2024/0004705 A1
(43) Pub. Date: Jan. 4, 2024

(54) DEVICES, SYSTEMS, AND METHODS FOR HANDLING POWER SWINGS

(71) Applicant: NVIDIA Corporation, Santa Clara, CA (US)

(72) Inventors: Chad Robert Plummer, San Rafael, CA (US); Pratikkumar Dilipkumar Patel, Milpitas, CA (US); Jun Gu, San Jose, CA (US); Tao Li, San Jose, CA (US); Divya Ramakrishnan, San Jose, CA (US); Michael Houston, Saratoga, CA (US)

(21) Appl. No.: 17/856,368

(22) Filed: Jul. 1, 2022

(51) Int. Cl. G06F 9/48

(52) U.S. Cl. CPC G06F 9/4893

(57) ABSTRACT

A device comprises one or more circuits that dynamically adjust a load profile of one or more processing devices processing a workload in a bulk-synchronous mode.

### FIELD

The present disclosure is generally directed to devices, systems, and methods for handling large power swings.

### BACKGROUND

Large scale consumers of power may cause large power swings on the power grid when stopping and starting consumption of large amounts of power. For example, as datacenters scale out, certain types of workloads are being processed with larger and larger processing clusters (e.g., clusters of processing devices, such as graphics processing units (GPUs)). Bulk-synchronous workloads are one such type of workload where the processing devices finish, and in some cases start, the workload at the same time or near the same time to avoid glitching. The power swing caused by these sudden starts and stops in the datacenter context and in other contexts may cause problems for power providers, which usually require minutes to respond to larger power swings (e.g., 2 megawatt swings) instead of milliseconds (e.g., hundreds of milliseconds).

### BRIEF SUMMARY

In an illustrative embodiment, a device comprises one or more circuits that dynamically adjust a load profile of one or more processing devices processing a workload in a bulk-synchronous mode.

In another illustrative embodiment, a cluster manager comprises at least one processor and memory including instructions that when executed by the at least one processor cause the at least one processor to determine, based on one or more power delivery specifications, one or more load profiles for one or more processing devices that process a workload in a bulk-synchronous mode, and send the one or more load profiles to the one or more processing devices.

In yet another illustrative embodiment, a Graphics Processing Unit (GPU) comprises one or more circuits that dynamically adjust a load profile for the GPU when the GPU is operated in a bulk-synchronous mode with one or more other GPUs.

Additional features and advantages are described herein and will be apparent from the following description and the figures.

### BRIEF DESCRIPTION OF THE DRAWINGS

The present disclosure is described in conjunction with the appended figures, which are not necessarily drawn to scale:

FIG. 1 illustrates a block diagram of a system according to at least one example embodiment.

FIG. 2 illustrates a block diagram of a system for managing and controlling load profiles of processing devices according to at least one example embodiment;

FIG. 3 illustrates an example ramp-down load profile for a workload release event according to at least one example embodiment;

FIG. 4 illustrates an example ramp-up load profile for a workload initiation according to at least one example embodiment;

FIG. 5 illustrates another example ramp-up load profile for a workload initiation according to at least one example embodiment;

FIG. 6 illustrates a method according to at least one example embodiment; and

FIG. 7 is a visual representation of power requirements for a site including a cluster of processing devices according to at least one example embodiment.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a PCB, or the like.

As used herein, the phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The terms “determine,” “calculate,” and “compute,” and variations thereof, as used herein, are used interchangeably and include any appropriate type of methodology, process, operation, or technique.

Various aspects of the present disclosure will be described herein with reference to drawings that may be schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

As used herein, the singular forms “a,” “an,” and “the” are intended to include the plural forms as well, unless the context clearly indicates otherwise. It will be further understood that the terms “include,” “including,” “includes,” “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

Throughout the instant description, elements having a same root reference numeral but different suffix may be referred to by only the root reference numeral when reference to a specific element is not necessary (e.g., elements XXXa, XXXb . . . XXXn may be referred as XXX for singular and plural forms).

Bulk-synchronous style workloads are being run on larger and larger GPU clusters. These workloads are typically optimized such that GPUs finish work at the same time (to avoid glitching), which may be achieved by fixing the GPUs to a same GPU frequency across the cluster. One feature of bulk-synchronous workloads is that high load steps (from a cluster level) are observed when the workload starts and/or when the workload stops (also called a workload release). In a datacenter environment, the starting and stopping a bulk-synchronous style workload may cause the system to experience many megawatts of power swing in tens of milliseconds, which causes corresponding power swings at a power provider that potentially damage equipment and/or cause energy distribution and/or consumption inefficiencies. In some cases, the operator of a datacenter has a service level agreement with a power provider where exceeding the agreed upon maximum power swing within a certain time period may incur a fine or other penalty for the operator. Bulk-synchronous start up workloads may trigger over current protection at a power supply unit (PSU) and/or power distribution unit (PDU). Related art fixes for a workload release issue include modifications to the datacenter infrastructure by including batteries and/or large capacitor banks. Datacenter upgrades, however, have large capital costs.

Inventive concepts propose to solve at least the above problems associated with large power swings for certain types of workloads (e.g., a bulk-synchronous workload) by controlling the cluster of processing devices (e.g., GPUs) handling the workload to adjust their respective load profiles using on-die current source circuits or on-die current throttle circuits for workload start events and/or on-die current sink circuits for workload release events. Upon detecting a workload release event, for example, each processing device in the cluster (e.g., each GPU) may continue to use power at a specified ramp-down rate with the aid of an on-die current sink circuit. In another example, each processing device in the cluster may use power at a specified ramp-up rate with the aid of an on-die current throttle. In any event, the specified ramp rates may be adjustable at runtime or fixed prior to runtime.

Inventive concepts help reduce the extra cost associated with modifying the data center with batteries and capacitor banks by enabling custom cluster ramp-down and/or ramp-up load profiles for each processing device (e.g., each GPU). GPUs are already populated with adequate cooling and electrical capabilities, and so no additional component cost is necessary. In addition, inventive concepts enable cost savings with less over-provisioning of over-current protection circuits for PDUs and/or PSUs to handle GPU ramp up and/or help the operator of the datacenter avoid penalties for exceeding agreed upon maximum power swings.

At least one embodiment comprises a cluster manager to help improve performance (e.g., to maximize performance per watt). The cluster manager may be implemented with software and/or hardware that determines and provides ramp-up and/or ramp-down load profiles to each GPU in the cluster. In at least one example, the cluster manager performs these tasks dynamically and enables each GPU to handle workloads other than bulk-synchronous workloads (e.g., if GPUs of a cluster are running asynchronous workloads, the cluster manager may enable a GPU to disable the use of ramp-up and/or ramp-down load profiles to avoid wasting power).

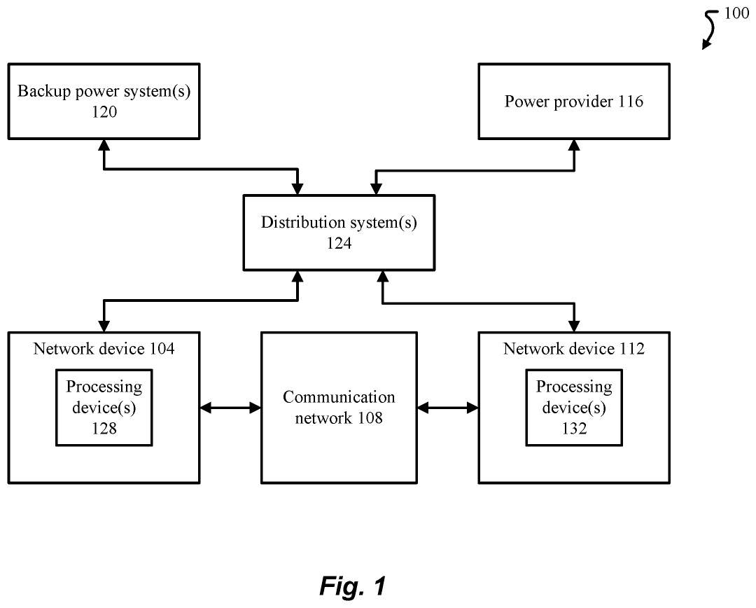

FIG. 1 illustrates a block diagram of a system 100 according to at least one example embodiment. The system 100 includes a network device 104, a communication network 108, a network device 112, a power provider 116, backup power system(s) 120, and/or distribution system(s) 124. In one non-limiting embodiment, the network devices 104 and 112, the communication network 108, the distribution system(s) 124, and/or the backup power system(s) 120 are included as part of a datacenter.

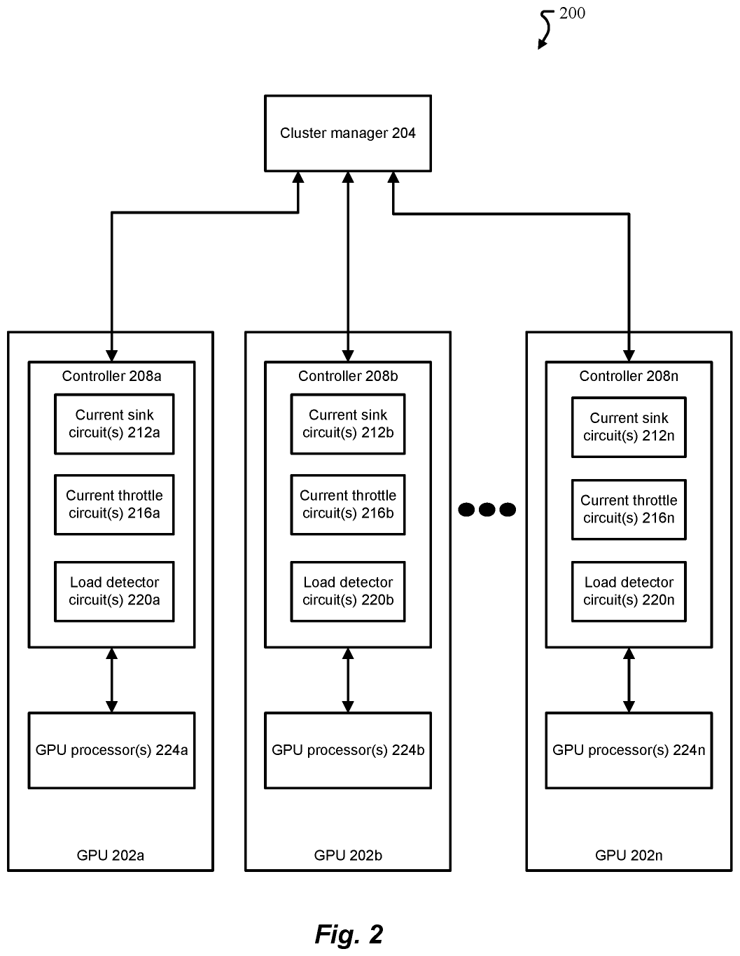

In at least one example embodiment, network devices 104 and 112 correspond to or include one or more processing devices 128 and 132 that are capable of running a bulk-synchronous workload as part of a cluster. Non-limiting examples for the bulk-synchronous workload include workloads for Natural Language Processing (NLP), workloads for reinforcement learning, workloads for artificial intelligence, workloads for complex image processing, and/or the like. In one non-limiting embodiment, the processing devices 128 and 132 each include one or more GPUs for processing the workloads described herein (see GPUs 202 in FIG. 2). Embodiments are not limited to using GPUs and other processing devices may handle bulk-synchronous workloads, such as central processing units (CPUs), data processing units (DPUs), and/or the like. Each network device 104 and 112 may additionally or alternatively include other components, such as a network switch (e.g., an Ethernet switch), a network interface controller (NIC), a CPU, a DPU, or any other suitable device used to process data and/or control the flow of data between devices connected to communication network 108. Each network device 104 and 112 may include or be connected to one or more of Personal Computer (PC), a laptop, a tablet, a smartphone, a server, a collection of servers, and/or the like. Although only two network devices are shown, more or fewer network devices may be included in the system 100.

Examples of the communication network 108 that may be used to connect the network devices 104 and 112 include an Internet Protocol (IP) network, an Ethernet network, an InfiniBand (IB) network, a Fibre Channel network, the Internet, a cellular communication network, a wireless communication network, combinations thereof (e.g., Fibre Channel over Ethernet), variants thereof, and/or the like. In one specific, but non-limiting example, the communication network 108 is a network that enables communication between the network devices 104 and 112 using Ethernet technology. The communication network 108 may be implemented with optical fibers, electrical traces or wires, and/or other suitable hardware and/or software for carrying data traffic.

The one or more processing devices 128 and the one or more processing devices 132 may include one or more processing circuits for carrying out computing tasks, for example, tasks associated with processing data and/or controlling the flow of data within each network device 104 and 112 and/or over the communication network 108. Such processing circuits may comprise software, hardware, or a combination thereof. For example, a processing circuit may include a memory including executable instructions and at least one processor (e.g., a microprocessor) that executes the instructions on the memory. The memory may correspond to any suitable type of memory device or collection of memory devices configured to store instructions. Non-limiting examples of suitable memory devices that may be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally or alternatively, a processing circuit may comprise hardware, such as an application specific integrated circuit (ASIC). Other non-limiting examples of the processing circuits include an Integrated Circuit (IC) chip, a Central Processing Unit (CPU), a microprocessor, a Field Programmable Gate Array (FPGA), a collection of logic gates or transistors, resistors, capacitors, inductors, diodes, or the like. Some or all of the processing circuits may be provided on a Printed Circuit Board (PCB) or collection of PCBs. It should be appreciated that any appropriate type of electrical component or collection of electrical components may be suitable for inclusion in the processing circuitry.

In addition, although not explicitly shown, it should be appreciated that the network devices 104 and 112 include additional processing circuits and/or one or more communication interfaces for facilitating wired and/or wireless communication between one another and other unillustrated elements of the system 100.

The power provider 116 may correspond to a utility company that provides power to elements of the system 100 (e.g., with the aid of the distribution system(s) 124). As described herein, the power provider 116 may experience problems with responding to rapid, large power swings upon the start and/or stop of bulk-synchronous workload being processed by a cluster GPUs or other processing device of the network devices 104 and/or 112. As also shown, the system 100 may include one or more backup power systems 120 that provide power to the elements of the system 100 when the power provider 116 is unable to meet demand as the result of an outage or exceeding a maximum power output. A backup power system may comprise one or more power generators (e.g., diesel generators).

The distribution system(s) 124 may comprise one or more devices or systems that aid the supply of power from the power provider 116 and/or backup power system(s) 120 to the network devices 104 and 112. The distribution system(s) 124 may include switchgear systems, uninterruptable power supplies (UPSs), power distribution units (PDUs), remote power panels, rack power strips, and/or other suitable systems for ensuring proper power supply within the system 100.

FIG. 2 illustrates a block diagram of a system 200 for managing load profiles of processing devices according to at least one example embodiment. The system 200 includes GPUs 202a, 202b . . . 202n, a cluster manager 204, and controllers 208a, 208b . . . 208n. As may be appreciated, more or fewer GPUs 202 having the same or similar structure as GPUs 202a to 202n may be included in the system 200. As noted above for FIG. 1, network devices 104 and 112 may comprise a cluster of processing devices embodied as processing devices 128 and/or 132 for handling workloads. FIG. 2 illustrates an example where the cluster of processing devices 128 and/or 132 include or are implemented with the GPUs 202a, 202b . . . 202n. Each GPU 202 includes a respective controller 208a, 208b . . . 208n, and each controller 208a, 20b8b . . . 208n may correspond to a Baseboard Management Controller (BMC) of a GPU or a Graphics Processing Management Unit (GPMU) of a GPU. Controllers 208a to 208n may have the same or similar processing capabilities and/or processor structures as those described herein with respect to processing devices 128 and 132. In at least one non-limiting embodiment, each controller 208a to 208n comprises a System on Chip (SoC) Advanced RISC Machine-based processor (ARM-based processor). Each controller 208a to 208n may, among other things, perform tasks for an associated GPU 202a to 202n, such as environment monitoring (for temperature, humidity, particulates, etc.), power management, diagnostics, and/or the like.

The cluster manager 204 comprises suitable hardware and/or software for performing tasks related to generating load profiles for the GPUs 202 to dynamically control GPU power in cooperation with controllers 208, as described herein. The cluster manager 204 may have the same or similar processing capabilities and/or processor structures as those described herein with respect to the processing devices 128 and 132. As may be appreciated, the cluster manager 204 may be separate from the GPUs 202 (as in FIG. 2), included as part of a master GPU 202 that communicates information to other GPUs 202 in a cluster, and/or included with each GPU 202.

As shown in FIG. 2, each controller 208a to 208n includes one or more current sink circuits (212a, 212b, and 212c), one or more current throttle circuits (216a, 216b, and 216c), and one or more load detector circuits (220a, 220b, 220c). The current sink circuit(s) 212, the current throttle circuit(s) 216, and/or the load detector circuit(s) 220 for each controller 208 may be fabricated on the same SoC as the aforementioned BMC or GPMU. In this way, the current sink circuit(s) 212, the current throttle circuit(s), and/or the load detector circuit(s) are “on-die” circuits.

Each GPU 202a to 202n may include one or more GPU processors 224a to 224n, respectively. The GPU processors 224a, 224b . . . 224n comprise suitable hardware and/or software for processing workloads (e.g., bulk-synchronous workloads, asynchronous workloads, and/or the like). GPU processor(s) 224 may have the same or similar processing capabilities and/or structures as those described herein with respect to processing devices 128 and 132. Although not explicitly shown, a controller 208 and a GPU processor 224 may be mounted on a same printed circuit board (PCB) or other suitable substrate along with one or more additional, unillustrated, elements of a GPU 202 (e.g., electrical traces, sensors, other processors, and/or the like).

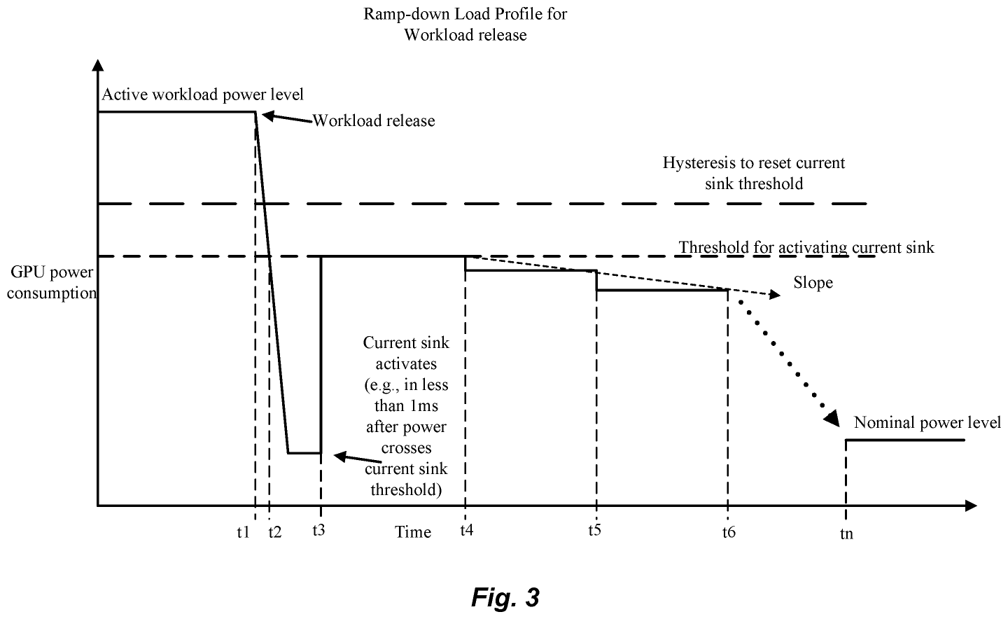

The current sink circuits 212a to 212n may comprise one or more circuits suitable for sinking current to thereby consume power in a manner that limits a power drop of a respective GPU 202 upon a workload release event at the end of a bulk-synchronous workload being processed (e.g., by GPU processor(s) 224). Each current sink circuit 212 may be controlled by a respective controller 208 according to a ramp-down load profile received from cluster manager 204 and stored in memory (not shown) of the controller 208 (see FIG. 3). A current sink circuit 212 may comprise a collection or transistors, operational amplifiers, resistors, and/or other electronic components in a configuration suitable for sinking current. Additionally or alternatively, a current sink circuit 212 may comprise one or more circuits that enable a GPU 202 to process an additional workload as part of applying the ramp-down load profile to the GPU 202. The additional workload may be a useful workload that produces useable results. For example, the additional workload may be an asynchronous workload that is already queued for processing by a GPU processor 224 of a GPU 202. In this case, the current sink circuit 212 may enable or be embodied by GPU processor(s) 224 continuing to process the additional workload as part of handling the workload release event of the bulk-synchronous workload. In another embodiment, the additional workload is considered wasteful or not useful. In this case, a current sink circuit 212 may enable or be embodied by GPU processor(s) 224 running a preset algorithm or processing predefined data in a manner that causes power consumed by a GPU 202 to match an associated ramp-down load profile.

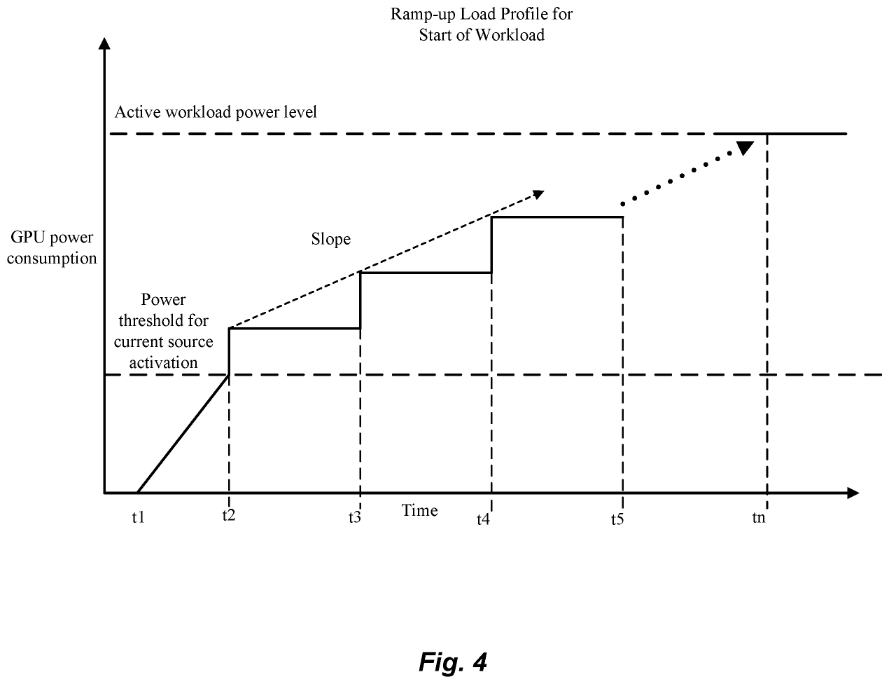

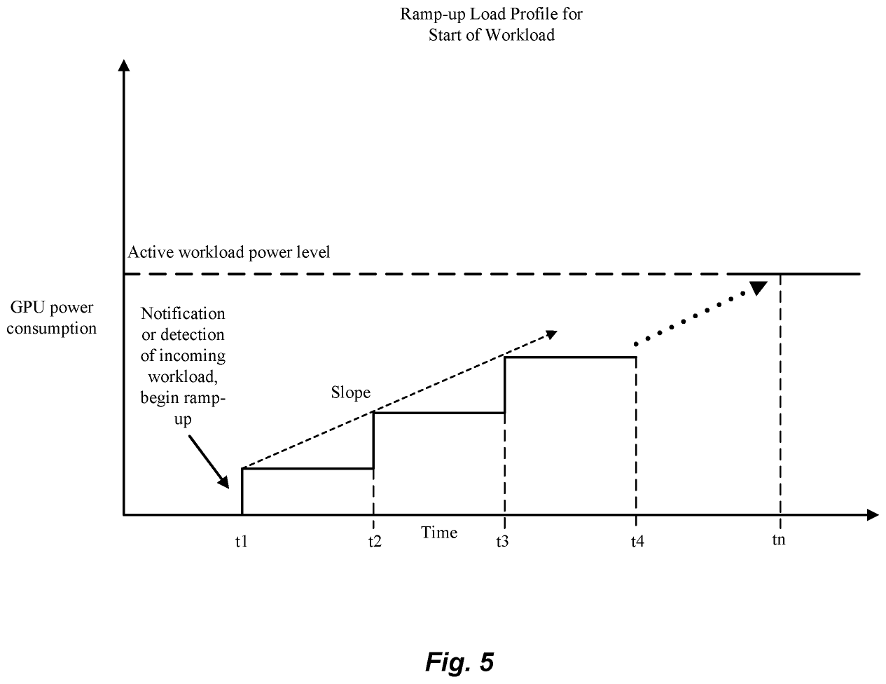

The current throttle circuits 216a to 216n may comprise one or more circuits suitable for sourcing current to limit power consumed by a respective GPU 202 at or prior to a beginning of a bulk-synchronous workload. Each current throttle circuit 216 may be controlled by a respective controller 208 according to a ramp-up load profile received from cluster manager 204 and stored in memory (not shown) of the controller 208 (see FIGS. 4 and 5). A current throttle circuit 216 may comprise a collection or transistors, operational amplifiers, resistors, and/or other electronic components in a configuration suitable for limiting current in accordance with a ramp-up load profile. In at least one embodiment, a current throttle circuit 216 comprises a current source. Additionally or alternatively, a current throttle circuit 216 may comprise one or more circuits that enable a GPU 202 to process an additional workload as part of a ramp-up load profile to the GPU 202. The additional workload may be a useful workload that produces useable results. For example, the additional workload may be an asynchronous workload that is already queued for processing by a GPU processor 224 of a GPU 202. In this case, the current throttle circuit 216 may enable or be embodied by GPU processor(s) 224 processing the additional workload as part of initiating the bulk-synchronous workload. In another embodiment, the additional workload is considered wasteful or not useful. In this case, a current throttle circuit 216 may enable or be embodied by GPU processor(s) 224 running a predefined algorithm or processing preset data in a manner that causes power consumed by a GPU 202 to match an associated ramp-up load profile.

FIG. 2 further illustrates that each controller 208 includes one or more load detector circuits 220a, 220b . . . 220n. A load detector circuit 220 may include one or more circuits that monitor a load of a respective GPU 202. The load detector circuit 220 may comprise one or more suitable current sensors that sense GPU current consumption, voltage sensors that sense GPU voltage consumption, and/or power sensors that sense GPU power consumption. Such current, voltage, and/or power sensors may comprise electronic components such as inductors, capacitors, resistors, amplifiers, and/or transistors in a configuration that enables a controller 208 to monitor how much power is being consumed by a respective GPU 202. As discussed in more detail below, output of the load detector circuits 220 may trigger the controllers 208 to implement a ramp-up and/or ramp-down load profile for a bulk-synchronous workload being processed by a GPU 202.

As noted above, the cluster manager 204 carries out tasks related to controlling load profiles of the GPUs 202 in cooperation with controllers 208. For example, the cluster manager 204 determines one or more load profiles for one or more of the GPUs 202 that process a workload in a bulk-synchronous mode. The load profiles may be determined by the cluster manager based on one or more power delivery specifications provided by a power provider 116 and/or by an operator of a datacenter. Power delivery specifications may include information such as maximum power capabilities of a power provider 116, maximum allowable power swing thresholds (upswing thresholds and/or downswing thresholds) tolerated or agreed upon by the power provider 116 and/or the datacenter over a certain period of time, and/or the like. The cluster manager 204 may take the power delivery specifications into account to determine appropriate load profiles for a cluster of GPUs 202. For example, if the power delivery specifications indicate that the system should not experience a maximum power swing of greater than 1 megawatt over 4 minutes, then the cluster manager 204 determines load profiles for the cluster of GPUs 202 in manner that prevents (or reduces the likelihood of) the maximum power swing from being exceeded within 4 minutes of a start of a bulk-synchronous workload and/or within 4 minutes after an end of a bulk-synchronous workload. Determining a load profile may comprise determining slope information that notifies a controller 208 of a predetermined slope that the ramp-up or ramp-down load profile should maintain for a designated time period (e.g., 4 minutes). The cluster manager 204 may take various factors into account to determine load profiles that meet the power delivery specifications. Such factors may include but are not limited to a size of the workload, a number of GPUs in a cluster, estimated per-GPU power consumption while processing the workload, an estimated per-GPU power drop upon workload release, historical power consumption data captured from previous workloads, historical data from previous workloads of the same or other GPU clusters that used ramp-up and ramp-down load profiles, and/or the like. A ramp-up load profile may be determined based on a trip curve of a protection device (e.g., an over-current protection device like a circuit breaker) for a PDU and/or a PSU that powers a GPU 202. In the art, a trip curve is indicative of a protection device's tripping conditions which can be translated into a ramp-up load profile that limits peaks in power consumption over time in accordance with the trip curve. In at least one embodiment, a load profile may be determined based on a number of GPUs processing the bulk-synchronous workload and a maximum power swing. For example, if a datacenter is provisioned for a +/−5 MW swing over an amount of time (e.g., one minute) with a power provider 116 and there are 20,000 GPUs 202 in the cluster, then load profiles for the GPUs 202 determined by the cluster manager 204 may allow each GPU to swing 250 W up or down with any swing greater than 250 W requiring a 250 W/min ramp down slope. In the event that one or more GPUs in the cluster are consuming more power than other GPUs 202 during ramp-up or ramp-down, the cluster manager 204 may determine load profiles for the GPUs 202 consuming more power dynamically to help mitigate a large power swing.

The cluster manager 204 may then send information including the one or more load profiles to each controller 208 of each GPU 202. As described herein, the load profiles may comprise GPU-specific ramp-down load profiles applied at an end of a bulk-synchronous workload and/or GPU-specific ramp-up load profiles applied at or prior to a beginning of a bulk-synchronous workload.

The information sent from cluster manager 204 to controllers 208 along with the load profiles may further comprise GPU-specific power thresholds that a controller 208 uses to determine when to apply a ramp-up load profile and/or ramp-down load profile. Still further, the cluster manager 204 may send information or signals that enable a controller 208 to enable and disable the adjustment of load profiles. For example, the cluster manager 204 may instruct a controller 208 to enable load profile adjustment for bulk-synchronous workloads and to disable load profile adjustment for other types of workloads (e.g., asynchronous workloads). The enable/disable instruction may be sent by the cluster manager 204 in real-time as part of notifying a GPU 202 of an incoming workload and the type of workload (bulk-synchronous or not). Additionally or alternatively, the cluster manager 204 may send the enable/disable instruction at sometime prior to an incoming workload. In this case, a controller 208 may store the instruction in memory (not shown) and have the capability to distinguish a bulk-synchronous workload from other workloads to effectively carry out the enable/disable function. For example, a controller 208 may receive a notification of or detect that a clock of a respective GPU processor 224 is synchronized with clocks of other GPU processors 224, thereby indicating the start of a bulk-synchronous workload for a cluster of GPUs 202.

Here, it should be appreciated that the cluster manager 204 sends the above information that includes power thresholds, enable/disable signals, and/or load profiles (e.g., with slope information) on a per-GPU basis. In some cases, power thresholds and/or load profiles sent by the cluster manager 204 are the same for some or all GPUs or processing devices in the system 200 (e.g., where a grouping of GPUs are the same model or have the same or similar capabilities (similar processing capability, similar cooling capability, etc.)). However, example embodiments are not limited thereto, and the power thresholds, and/or load profiles may be different across the processing devices or GPUs (e.g., when a grouping of GPUs have different models or dissimilar processing and/or cooling capabilities).

In addition, although the cluster manager 204 determines and sends load profiles and the information on a per-GPU basis, the information and load profiles may be determined by the cluster manager 204 so that an overall load profile of the system that includes the cluster of GPUs processing the bulk-synchronous workload and other power consuming components of the system (e.g., network switches, servers, etc.) meets the power delivery specifications. For example, the load profiles and associated information are determined such that the overall load profile for the entire system 100 does not exceed a maximum power swing as specified by the power provider 116 or datacenter operator. Thus, the cluster manager 204 may take power consumption of other components in the system 100 into account when determining the load profiles and thresholds for GPUs 202 (e.g., power thresholds, slope steepness thresholds). In at least one embodiment, the cluster manager 204 instructs a controller 208 to adjust a load profile in real-time to account for changes in the power consumption of other elements in the system.

FIG. 3 illustrates an example ramp-down load profile for a workload release event according to at least one example embodiment. The ramp-down load profile of FIG. 3 (or similar profile) may be applied to one or more GPUs 202 of a cluster of GPUs at the end of a bulk-synchronous workload release to avoid a rapid, large power swing caused by the cluster of GPUs reducing their power consumption at substantially the same time. Prior to time t1, a GPU 202 consumes power at an active workload power level. At time t1, the GPU 202 has completed the workload and power consumption begins to fall rapidly upon workload release. At time t2, the GPU power consumption crosses a power threshold for activating one or more current sink circuits 212. As described above, the power threshold may be determined and provided by the cluster manager 204 to a controller 208 of the GPU 202. The controller 208 may utilize output of a load detector circuit 220 to determine that the power threshold for activating a current sink circuit has been crossed. At time t3, the current sink circuit(s) 212 of the GPU 202 are activated, which raises the GPU power consumption back to a some desired level, in this case the same power threshold that activates the current sink circuit(s) 212 (although other initial power levels may be used). Thus, time t3 signals the beginning of dynamically adjusting the GPU's 202 ramp-down load profile using the current sink circuit(s) 212. Here, it should be appreciated, that the time elapsed between t2 and t3 is short enough to avoid the problems associated with rapid, large power sings caused by the cluster of GPUs simultaneously finishing a workload. In at least one example, the time elapsed between t2 and t3 is less than lms. Thereafter, the current sink circuit(s) 212 sink current in a manner that matches the remainder of the ramp-down load profile from time t3 to time tn.

In the example of FIG. 3, the load profile follows a step pattern in which GPU power consumption is reduced in steps at time t4, time t5, time t6 all the way through time tn at which point the GPU is consuming a nominal power level (additional time points represented with the dotted arrow from time t6 to time tn). The nominal power level represents the end of dynamically adjusting the GPU's 202 load profile, and thus, the controller 208 may deactivate the current sink circuit(s) 212 at time tn. In at least one embodiment, the step-down pattern may follow a predetermined slope through one point of each step, which may be determined by the cluster manager 204 and provided to the controller 208 as part of the slope information for the ramp-down load profile. The amount of power consumption drop and the length of each step may be the same or different for one or more of the steps. In addition, the amount of power consumption drop and the length of each step may be predefined or vary in real-time under control of the controller 208 which provides the ability to respond to transient conditions. Although the step pattern in FIG. 3 may be more easily implemented than other patterns, the ramp-down load profile in FIG. 3 is not limited to a step pattern, and other suitable patterns may be implemented depending on the capabilities of the current sink circuit(s) 212. For example, the load profile may have a substantially linear power drop that substantially follows the slope depicted in FIG. 3. In any event, the overall or average slope of a ramp-down load profile is generally less steep than the overall or average slope of the power drop between time t1 and time t2. As may be appreciated, time t3 to time to may span a number of minutes (e.g., 3 minutes, 5 minutes, 10 minutes) to avoid causing a rapid, large power swing upon the cluster of GPUs 202 experience a near simultaneous workload release event.

FIG. 3 further illustrates a hysteresis line for resetting the power threshold that activates current sink circuit(s) 212. For example, when GPU 202 power consumption repeatedly falls below the hysteresis line but then rises back above the line due to, for example, a workload of a GPU decreasing and then increasing, the power threshold may be adjusted down (reset) accordingly. On the other hand, the power threshold may be adjusted up if, for example, the power consumption consistently remains above the hysteresis line.

Here, it should be appreciated that FIG. 3 illustrates a reactive method for responding to a workload release event in which current sink circuit(s) 212 are activated in response to a power threshold being crossed. However, it should be appreciated that the load profile of FIG. 3 may be implemented or initiated in a predictive manner. For example, a controller 208 may estimate or receive a notification of an expected end time for the workload, and begin dynamically adjusting the GPU's 202 load profile at some specified time before the workload release event. In this case, the step pattern (or other suitable pattern) applied at time t3 in FIG. 3 may have at least a portion of the pattern implemented prior to time t1 while the GPU 202 is still processing the workload. In this case, the controller 208 does not necessarily wait for a drop in GPU power consumption into account before starting to dynamically adjust the load profile. If the estimated end time for the workload is extended at any point or if the end time passes but the workload is still being processed, the controller 208 may deactivate the current sink circuit(s) 212 and allow the GPU power consumption to return to the active workload power level.

FIGS. 4 and 5 illustrate example ramp-up load profiles for a workload initiation according to at least one example embodiment. The ramp-up load profiles of FIGS. 4 and 5 (or similar profiles) may be applied to one or more GPUs 202 of a cluster of GPUs at or prior to the initiation of a bulk-synchronous workload to avoid a rapid, large power swing caused by the cluster of GPUs increasing their power consumption at substantially the same time. As may be appreciated, the ramp-up load profile of FIG. 4 is substantially the opposite of a ramp-down load profile. In addition, a ramp-up load profile may be implemented with current throttle circuit(s) 216 of a controller 208.

With reference to FIG. 4, power consumption of a GPU 202 may be at zero or at some nominal power level above zero. Time t1 signals the initiation of a workload, for example, a bulk-synchronous workload that uses a cluster of GPUs 202 to process the workload. At time t2, the controller 208 may determine that GPU power consumption passes or meets a power threshold based on output of load detector circuit(s) 220. Meeting or exceeding the power threshold triggers activation of current throttle circuit(s) 216 of the controller 208 at time t2, which signals the beginning of dynamically adjusting the load profile of the GPU 202. Thereafter, the current throttle circuit(s) 216 operate in a manner that causes the GPU ramp-up load profile to follow a step pattern that raises at times t3, t4, t5 all the way to time tn (additional time points represented with the dotted arrow from time t5 to time tn). At time tn, the GPU 202 is consuming power at an active workload power level to process the GPU's share of the bulk-synchronous workload initiated at time t1, and thus, the controller 208 may deactivate the current throttle circuit(s) 216. As may be appreciated, time t2 to time tn may span a suitable amount of time (e.g., milliseconds, hundreds of milliseconds, 3 minutes, 5 minutes, 10 minutes) to avoid causing a rapid, large power swing at the beginning of the workload. The amount of time between t2 and tn may be determined by the trip curves of any over-current protection devices for PSU or PDU that powers a GPU 202.

In at least one embodiment, the step-up pattern in FIG. 4 may follow a predetermined slope through one point of each step, which may be determined by the cluster manager 204 and provided to the controller 208 as part of the slope information for the ramp-down load profile. The amount of power consumption rise and the length of each step may be the same or different for one or more of the steps. In addition, the amount of power consumption rise and the length of each step may be predefined or vary in real-time under control of the controller 208 which provides the ability to respond to transient conditions. Although the step pattern in FIG. 4 may be more easily implemented than other patterns, the ramp-down load profile in FIG. 4 is not limited to a step pattern, and other suitable patterns may be implemented depending on the capabilities of the current throttle circuit(s) 216. For example, the load profile may have a substantially linear power rise that substantially follows the slope depicted in FIG. 4. In any event, the overall or average slope of a ramp-up load profile is generally less steep than the overall or average slope of the power rise between time t1 and time t2.

In FIGS. 3 and 4, the load profile of a GPU is not dynamically adjusted until a power threshold is met or crossed. However, dynamic adjustment may not begin until alternative or additional conditions are met. For example, in at least one embodiment, a controller 208 may also take into account whether a slope of the power drop between times t1 and t2 in FIG. 3 and a slope of the power rise between times t1 and t2 in FIG. 4 cross steepness thresholds. For example, in the ramp-down load profile of FIG. 3, a controller 208 may not activate the current sink circuit(s) 212 until the power threshold is crossed and a slope of the power drop between times t1 and t2 exceeds a threshold steepness. In other words, a steepness of the slope in the power drop may be indicative of whether a workload release event has actually occurred versus the GPU power consumption temporarily dropping below the power threshold while still processing the workload. In this case, the temporary drop in GPU power consumption below the power threshold may have an average slope that is not as steep as the average slope would be for a workload release event. The same concept for meeting two conditions (a power threshold and a steepness threshold) may also be applied to the ramp-up load profile of FIG. 4.

The power thresholds and/or slope steepness thresholds shown in and/or described with reference to FIGS. 3 and 4 may be determined by the cluster manager 204 based on empirical evidence and/or preference. For example, the power and/or steepness thresholds for activating the circuits 212 and 216 may be set to a level that is known to be associated with the end or beginning of a bulk-synchronous workload. The power and/or steepness thresholds may be adjusted over time by the cluster manager 204 and/or by a controller 208. In at least one embodiment, the power and/or steepness thresholds are adjusted on a per-workload basis to accommodate workloads that have different active workload power levels for a GPU 202.

FIG. 5 illustrates another example of a ramp-up load profile according to at least one example embodiment. The concepts described above with reference to the load profile in FIG. 4 may be applied in the same or similar manner to FIG. 5. In FIG. 5, dynamically adjusting the load profile in FIG. 5 is initialized in response to a notification or detection of an incoming workload, for example, an incoming bulk-synchronous workload for a GPU 202. In FIG. 5, then, the notification of the incoming workload is substituted for the power threshold in FIG. 4. The notification of the incoming workload may be sent to a controller 208 by the cluster manager 204 upon the cluster manager 204 becoming aware of the incoming workload. In at least one example, the controller 208 may receive a notification of or detect that a clock of a respective GPU processor 224 is synchronized with clocks of other GPU processors 224, thereby indicating the start of a bulk-synchronous workload for a cluster of GPUs 202. In yet another example, the controller 208 may detect or receive a notification that a bulk-synchronous workload is queued for processing at a particular time, predict the start time of the workload, and then begin applying the ramp-up load profile in accordance with the prediction.

In any event, time t1 signals the time at which the controller 208 is notified of or detects an incoming bulk-synchronous workload to be processed by a cluster of GPUs 202. At time t1, the controller 208 activates the current throttle circuit(s) 216 to begin dynamically adjusting the ramp-up load profile in the same or similar manner as that described above for FIG. 4. For example, the load profile follows a step pattern that rises at times t2, t3, t4 all the way to tn (additional time points represented with the dotted arrow from time t4 to time tn). In any event, the workload may be initiated at or after time tn or at any time between t1 and tn. As in FIG. 4, the amount of time for the ramp-up load profile may be determined by the trip curves of any over-current protection devices for PSU or PDU that powers a GPU 202 (e.g., milliseconds, hundreds of milliseconds, minutes, etc.).

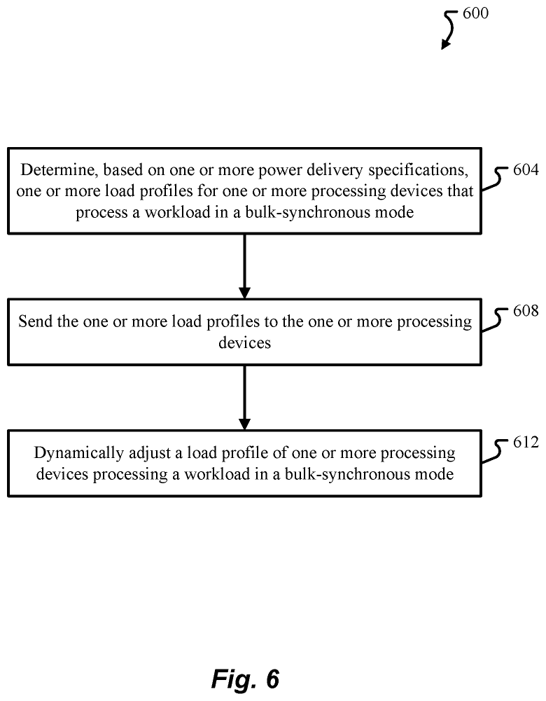

FIG. 6 illustrates a method 600 according to at least one example embodiment. While a general order for the operations of the method 600 is shown in FIG. 6, the method 600 can include more or fewer steps or can arrange the order of the operations differently than those shown in FIG. 6. The method 600 may be executed as a set of computer-executable instructions encoded or stored on a computer readable medium (e.g., memory) and executed by one or more processing circuits or devices described herein. Additionally or alternatively, the operations discussed with respect to FIG. 6 may be implemented by the various elements of the system(s) in FIGS. 1-2. Hereinafter, the method 600 shall be explained with reference to the systems, components, assemblies, devices, environments, software, etc. described in conjunction with FIGS. 1-5.

Operation 604 includes determining, based on one or more power delivery specifications, one or more load profiles for one or more processing devices that process a workload in a bulk-synchronous mode. The one or more processing devices may correspond to processing device(s) 128 and/or processing device(s) 132. In at least one embodiment, the one or more processing devices comprise a plurality of GPUs 202. The cluster manager 204 may determine the one or more load profiles based on the one or more power delivery specifications in accordance with the above description. Operation 608 includes sending the one or more load profiles to the one or more processing devices. Operation 608 may further include sending other information along with the load profiles, such as power thresholds, enable/disable signals, and/or slope information. This information and the load profiles may be tailored to specific GPUs 202 in a cluster. The one or more processing devices (e.g., GPUs 202) may store the information and load profiles in memory (e.g., memory of a controller 208).

Operation 612 includes dynamically adjusting a load profile of the one or more processing devices processing a workload in a bulk-synchronous mode. For example, operation 612 includes the controller 208 applying the load profiles in FIGS. 3-5 to one or more GPUs 202 in the cluster to avoid rapid, large power swings. Dynamically adjusting the load profile for a GPU may include the controller 208 employing current sink circuits 212 and current throttle circuits 216 to achieve a desired pattern for the load profile (e.g., a step-down pattern or a step-up pattern). In some cases, the pattern of a load profile substantially adheres to a predefined slope. The controller 208 may adjust the load profile according to predefined parameters (e.g., step size and length) or in real-time to achieve the desired slope.

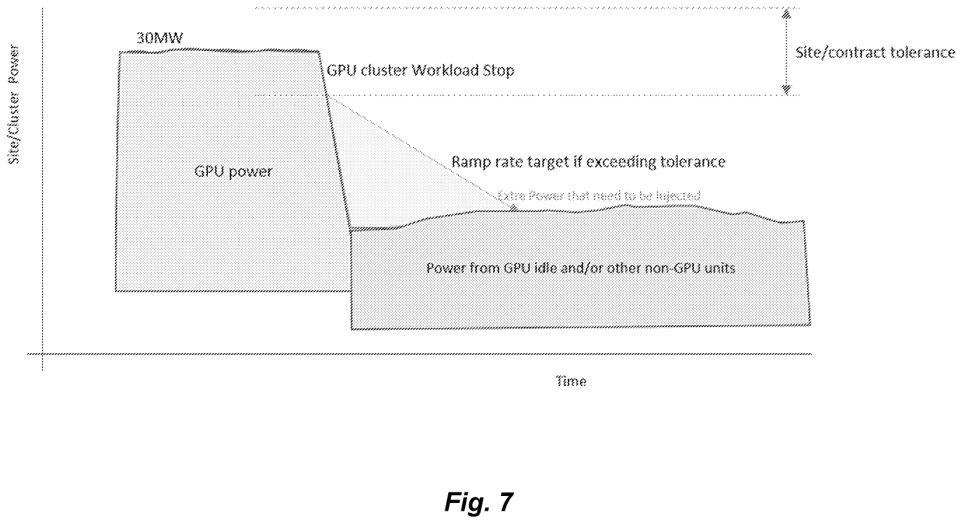

FIG. 7 is a visual representation of power requirements for a site including a cluster of processing devices according to at least one example embodiment. In FIG. 7, the cluster of processing devices may correspond to a cluster of GPUs processing a bulk-synchronous workload. As shown, the cluster of GPUs and other non-GPU units at the site may be consuming about 30 MW of power prior to a workload stop event where the cluster of GPUs are finished processing the workload. In this example, a site/contract tolerance is a power swing tolerance (e.g., 5 MW) defined by the site with the GPUs and/or by a written contract with a power provider 216. Upon exceeding the tolerance, the cluster of GPUs are controlled to consume power at a rate that achieves the ramp rate target defined by the arrow in FIG. 7 before the GPUs reach an idle state. The ramp rate target may be calculated dynamically (e.g., in real time) by a cluster manager 204 or pre-assigned by the cluster manager 204 (or, in some cases, pre-programmed on the GPUs).

In view of the above, at least one example embodiment is directed to a device (e.g., controller 208) comprising one or more circuits that dynamically adjust a load profile of one or more processing devices processing a workload in a bulk-synchronous mode (a bulk-synchronous mode may be a mode of a GPU 202 for processing a bulk-synchronous workload with other GPUs 202). The one or more processing devices comprise a plurality of Graphics Processing Units (GPUs), and the one or more circuits may comprise an on-die current sink circuit 212 integrated with the controller 208. As illustrated in FIG. 3, the load profile may be dynamically adjusted in response to detecting a workload release at an end of the workload being processed. As illustrated in FIGS. 4 and 5, the load profile may be dynamically adjusted in response to detecting a workload ramp-up at a beginning of the workload being processed. In at least one embodiment, the load profile is dynamically adjusted in response to predicting at least one of a workload release at an end of the workload being processed and a workload ramp-up at a beginning of the workload being processed. The one or more circuits are controlled by firmware of the one or more processing devices, such as firmware of the controller 208 of a GPU 202. In accordance with example embodiment, the one or more circuits dynamically adjust the load profile by injecting additional work after the workload (e.g., as in FIG. 3). As described herein, the additional work may be a useful workload that produces useable results. For example, the additional work may be an asynchronous workload that is already queued for processing by a GPU processor 224 of a GPU 202. In this case, a current sink circuit 212 may enable or be embodied by GPU processor(s) 224 continuing to process the additional workload as part of handling the workload release event of the bulk-synchronous workload. In another embodiment, the additional workload is considered wasteful or not useful. In this case, a current sink circuit 212 may enable or be embodied by GPU processor(s) 224 running a preset algorithm or processing predefined data in a manner that causes power consumed by a GPU 202 to match an associated load profile.

At least one example embodiment is directed to a cluster manager comprising at least one processor and memory including instructions that when executed by the at least one processor cause the at least one processor to determine, based on one or more power delivery specifications, one or more load profiles for one or more processing devices that process a workload in a bulk-synchronous mode, and send the one or more load profiles to the one or more processing devices. In at least one embodiment, the one or more processing devices comprise a plurality of processing devices which may correspond to a plurality of GPUs. In accordance with FIG. 3 and as noted above, additional work is injected to at least some of the plurality of processing devices after the workload is processed to control their respective load profiles. As discussed above, the one or more load profiles may comprise a ramp-down load profile applied at an end of the workload. Additionally or alternatively, the one or more load profiles may comprise a ramp-up load profile applied at a beginning of the workload.

In view of the above, example embodiments are directed to a GPU comprising one or more circuits (e.g., current sink circuits 212, current throttle circuits 216, and/or load detector circuits 220) that dynamically adjust a load profile for the GPU when the GPU is operated in a bulk-synchronous mode with one or more other GPUs. The one or more circuits receive information for the load profile from a cluster manager 204 that manages the GPU and the one or more other GPUs. As described herein, the information may comprise a first power threshold, and the one or more circuits begin dynamically adjusting the load profile in response to power consumed by the GPU dropping below the first power threshold. Additionally or alternatively, the information comprises slope information that governs how the one or more circuits dynamically adjust the load profile. In at least one embodiment, the information is based on a maximum power swing of a power provider 116. Additionally or alternatively, the information comprises a second power threshold, and the one or more circuits begin adjusting the load profile in response to power consumed by the GPU exceeding the second power threshold.

Although example embodiments have been shown and described with reference to power swings in datacenters, inventive concepts may be applied to any suitable application where a consumer of a large amount of power abruptly starts and/or stops consumption of that power. For example, a power consumer may have tens, hundreds, or thousands of the same or similar devices whose power start and/or stop consumption is relatively aligned in the same or similar manner described above for the GPUs processing a bulk-synchronous workload. In this case, the power consumer may throttle and/or sink current of the devices in the same or similar manner as that described herein for GPUs processing a bulk-synchronous workload.

Specific details were given in the description to provide a thorough understanding of the embodiments. However, it will be understood by one of ordinary skill in the art that the embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

It should be appreciated that inventive concepts cover any embodiment in combination with any one or more other embodiment, any one or more of the features disclosed herein, any one or more of the features as substantially disclosed herein, any one or more of the features as substantially disclosed herein in combination with any one or more other features as substantially disclosed herein, any one of the aspects/features/embodiments in combination with any one or more other aspects/features/embodiments, use of any one or more of the embodiments or features as disclosed herein. It is to be appreciated that any feature described herein can be claimed in combination with any other feature(s) as described herein, regardless of whether the features come from the same described embodiment.

Example embodiments may be configured according to the following:

(1) A device, comprising:
one or more circuits that dynamically adjust a load profile of one or more processing devices processing a workload in a bulk-synchronous mode.

(2) The device of (1), wherein the one or more circuits comprise an on-die current sink circuit.

(3) The device of one or more of (1) to (2), wherein the load profile is dynamically adjusted in response to detecting a workload release at an end of the workload being processed.

(4) The device of one or more of (1) to (3), wherein the load profile is dynamically adjusted in response to detecting a workload ramp-up at a beginning of the workload being processed.

(5) The device of one or more of (1) to (4), wherein the load profile is dynamically adjusted in response to predicting at least one of a workload release at an end of the workload being processed and a workload ramp-up at a beginning of the workload being processed.

(6) The device of one or more of (1) to (5), wherein the one or more circuits are controlled by firmware of the one or more processing devices.

(7) The device of one or more of (1) to (6), wherein the one or more circuits dynamically adjust the load profile by injecting additional work after the workload.

(8) The device of one or more of (1) to (7), wherein the one or more processing devices comprise a plurality of Graphics Processing Units (GPUs).

(9) A cluster manager, comprising:
at least one processor; and
memory including instructions that when executed by the at least one processor cause the at least one processor to:
   determine, based on one or more power delivery specifications, one or more load profiles for one or more processing devices that process a workload in a bulk-synchronous mode; and
   send the one or more load profiles to the one or more processing devices.

(10) The cluster manager of (9), wherein the one or more processing devices comprise a plurality of processing devices.

(11) The cluster manager of one or more of (9) to (10), wherein the plurality of processing devices comprise a plurality of Graphics Processing Units (GPUs).

(12) The cluster manager of one or more of (9) to (11), wherein additional work is injected to at least some of the plurality of processing devices after the workload is processed to control their respective load profiles.

(13) The cluster manager of one or more of (9) to (12), wherein the one or more load profiles comprises a ramp-down load profile applied at an end of the workload.

(14) The cluster manager of one or more of (9) to (13), wherein the one or more load profiles comprises a ramp-up load profile applied at a beginning of the workload.

(15) A Graphics Processing Unit (GPU), comprising:
one or more circuits that dynamically adjust a load profile for the GPU when the GPU is operated in a bulk-synchronous mode with one or more other GPUs.

(16) The GPU of (15), wherein the one or more circuits receive information for the load profile from a cluster manager that manages the GPU and the one or more other GPUs.

(17) The GPU of one or more of (15) to (16), wherein the information comprises a first power threshold, wherein the one or more circuits begin dynamically adjusting the load profile in response to power consumed by the GPU dropping below the first power threshold.

(18) The GPU of one or more of (15) to (17), wherein the information comprises slope information that governs how the one or more circuits dynamically adjust the load profile.

(19) The GPU of one or more of (15) to (18), wherein the information is based on a maximum power swing of a power provider.

(20) The GPU of one or more of (15) to (19), wherein the information comprises a second power threshold, wherein the one or more circuits begin adjusting the load profile in response to power consumed by the GPU exceeding the second power threshold.

What is claimed is:

1. A device, comprising:
one or more circuits that dynamically adjust a load profile of one or more processing devices processing a workload in a bulk-synchronous mode.

2. The device of claim 1, wherein the one or more circuits comprise an on-die current sink circuit.

3. The device of claim 1, wherein the load profile is dynamically adjusted in response to detecting a workload release at an end of the workload being processed.

4. The device of claim 1, wherein the load profile is dynamically adjusted in response to detecting a workload ramp-up at a beginning of the workload being processed.

5. The device of claim 1, wherein the load profile is dynamically adjusted in response to predicting at least one of a workload release at an end of the workload being processed and a workload ramp-up at a beginning of the workload being processed.

6. The device of claim 1, wherein the one or more circuits are controlled by firmware of the one or more processing devices.

7. The device of claim 1, wherein the one or more circuits dynamically adjust the load profile by injecting additional work after the workload.

8. The device of claim 1, wherein the one or more processing devices comprise a plurality of Graphics Processing Units (GPUs).

9. A cluster manager, comprising:
at least one processor; and
memory including instructions that when executed by the at least one processor cause the at least one processor to:
determine, based on one or more power delivery specifications, one or more load profiles for one or more processing devices that process a workload in a bulk-synchronous mode; and
send the one or more load profiles to the one or more processing devices.

10. The cluster manager of claim 9, wherein the one or more processing devices comprise a plurality of processing devices.

11. The cluster manager of claim 10, wherein the plurality of processing devices comprise a plurality of Graphics Processing Units (GPUs).

12. The cluster manager of claim 10, wherein additional work is injected to at least some of the plurality of processing devices after the workload is processed to control their respective load profiles.

13. The cluster manager of claim 9, wherein the one or more load profiles comprises a ramp-down load profile applied at an end of the workload.

14. The cluster manager of claim 13, wherein the one or more load profiles comprises a ramp-up load profile applied at a beginning of the workload.

15. A Graphics Processing Unit (GPU), comprising:
one or more circuits that dynamically adjust a load profile for the GPU when the GPU is operated in a bulk-synchronous mode with one or more other GPUs.

16. The GPU of claim 15, wherein the one or more circuits receive information for the load profile from a cluster manager that manages the GPU and the one or more other GPUs.

17. The GPU of claim 16, wherein the information comprises a first power threshold, wherein the one or more circuits begin dynamically adjusting the load profile in response to power consumed by the GPU dropping below the first power threshold.

18. The GPU of claim 17, wherein the information comprises slope information that governs how the one or more circuits dynamically adjust the load profile.

19. The GPU of claim 18, wherein the information is based on a maximum power swing of a power provider.

20. The GPU of claim 17, wherein the information comprises a second power threshold, wherein the one or more circuits begin adjusting the load profile in response to power consumed by the GPU exceeding the second power threshold.
